(19) United States
(12) Patent Application Publication
(10) Pub. No.: US 2023/0062694 A1
(43) Pub. Date: Mar. 2, 2023

(54) NAVIGATION APPARATUS AND METHOD

(71) Applicant: INSTITUTE FOR INFORMATION INDUSTRY, TAIPEI (TW)

(72) Inventors: I-Heng MENG, Taipei (TW); Ching-Wen LIN, Taipei (TW); Ai-Ting CHANG, Taipei (TW)

(21) Appl. No.: 17/450,071

(22) Filed: Oct. 5, 2021

(30) Foreign Application Priority Data
Aug. 25, 2021 (TW) 110131538

(51) Int. Cl. G01C 21/00

(52) U.S. Cl. CPC G01C 21/3874; G01C 21/3811; G01C 21/3889

(57) ABSTRACT

A navigation apparatus and method are provided. The apparatus receives an input data and at least a piece of positioning information. The apparatus performs a semantic analysis on the input data to generate a plurality of pieces of semantic information. The apparatus selects at least one of the semantic information as a filtering condition. The apparatus compares the filtering condition with a plurality of semantic tags in the map data to determine whether the semantic tags have at least one first semantic tag that meets the filtering condition. When determining that the semantic tags have the at least one first semantic tag, the apparatus generates a comparison result, wherein the comparison result is related to an object corresponding to the at least one first semantic tag. The apparatus generates a navigation route according to the comparison result and the at least a piece of positioning information.

### CROSS-REFERENCE TO RELATED APPLICATION

This application claims priority to Taiwan Application Serial Number 110131538, filed Aug. 25, 2021, which is herein incorporated by reference in its entirety.

### BACKGROUND

### Field of Invention

The present invention relates to a navigation apparatus and method. More particularly, the present invention relates to a navigation apparatus and method for comparing semantic tags of objects.

### Description of Related Art

Existing navigation services usually require users to input accurate name of the target (e.g., store), complete address or coordinates and other information in order to search for the target of the navigation, and then generate a navigation route for the user. However, when the user can only input part of the relevant information about the target, the existing navigation services cannot intelligently assist the user in finding the target for navigation.

In addition, the maintenance of existing map data requires special vehicles equipped with various sensors to obtain environmental data and object characteristics. For example, a data collection system used for high-precision maps is usually a vehicle equipped with multiple integrated sensors (such as LiDAR, GPS, IMU, etc.) to obtain the characteristics of roads and surrounding objects to update the map data. Due to the high cost and time-consuming of actual surveying, it is generally impossible to survey the same area again in a short period of time. As a result, the current map data may be different from the actual objects (such as stores) that still exist.

Accordingly, there is an urgent need for a technique that can provide a navigation technology for the semantic tag comparison of objects to quickly perform target navigation and further update map data.

### SUMMARY

An objective of the present invention is to provide a navigation apparatus. The navigation apparatus comprises a storage, a transceiver interface, and a processor, and the processor is electrically connected to the storage and the transceiver interface. The storage stores a map data, wherein the map data includes a plurality of objects and a plurality of semantic tags corresponding to each of the objects, each of the semantic tags is used to describe each corresponding object. The processor receives an input data and at least a piece of positioning information. The processor performs a semantic analysis on the input data to generate a plurality of pieces of semantic information. The processor selects at least one of the semantic information as a filtering condition. The processor compares the filtering condition with the semantic tags in map data to determine whether the semantic tags have at least one first semantic tag that meets the filtering condition. The processor generates a comparison result when determining that the semantic tags have the at least one first semantic tag, wherein the comparison result is related to the object corresponding to the at least one first semantic tag. The processor generates a navigation route according to the comparison result and the at least a piece of positioning information.

Another objective of the present invention is to provide a navigation method, which is adapted for use in an electronic apparatus. The electronic apparatus comprises a storage, a transceiver interface and a processor. The storage stores a map data, wherein the map data includes a plurality of objects and a plurality of semantic tags corresponding to each of the objects, each of the semantic tags is used to describe each corresponding object, and the navigation method is executed by the processor and the navigation method comprises the following steps: receiving an input data and at least a piece of positioning information; performing a semantic analysis on the input data to generate a plurality of pieces of semantic information; selecting at least one of the semantic information as a filtering condition; comparing the filtering condition with the semantic tags in map data to determine whether the semantic tags have at least one first semantic tag that meets the filtering condition; generating a comparison result when determining that the semantic tags have the at least one first semantic tag, wherein the comparison result is related to the object corresponding to the at least one first semantic tag, and generating a navigation route according to the comparison result and the at least a piece of positioning information.

According to the above descriptions, the navigation technology (including the apparatus and the method) provided by the present invention generates a plurality of pieces of semantic information by performing semantic analysis on input data, selects at least one of the semantic information as a filtering condition, and compares the filtering condition with the semantic tags in the map data to determine whether the semantic tags have at least one first semantic tag that meets the filtering condition. Next, the navigation technology generates a comparison result when determining that the semantic tags have the at least one first semantic tag, and generates a navigation route according to the comparison result and the at least a piece of positioning information. The navigation technology provided by the present invention generates a navigation route by analyzing the semantic information and comparing the semantic tags of objects in the map data, and solves the problems in the prior art that the conventional technology cannot intelligently assist the user in finding the target for navigation. In addition, the present invention also provides a technology for updating the map data in real-time, thereby overcoming the problem that the conventional technology cannot update the map data in real-time.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view depicting a navigation apparatus of the first embodiment;

FIG. 2 is a schematic view depicting a map data of the first embodiment;

FIG. 3 is a schematic view depicting a navigation apparatus of some embodiments; and

FIG. 4 is a partial flowchart depicting a navigation method of the second embodiment.

### DETAILED DESCRIPTION

In the following description, a navigation apparatus and method according to the present invention will be explained with reference to embodiments thereof. However, these embodiments are not intended to limit the present invention to any environment, applications, or implementations described in these embodiments. Therefore, description of these embodiments is only for purpose of illustration rather than to limit the present invention. It shall be appreciated that, in the following embodiments and the attached drawings, elements unrelated to the present invention are omitted from depiction. In addition, dimensions of individual elements and dimensional relationships among individual elements in the attached drawings are provided only for illustration but not to limit the scope of the present invention.

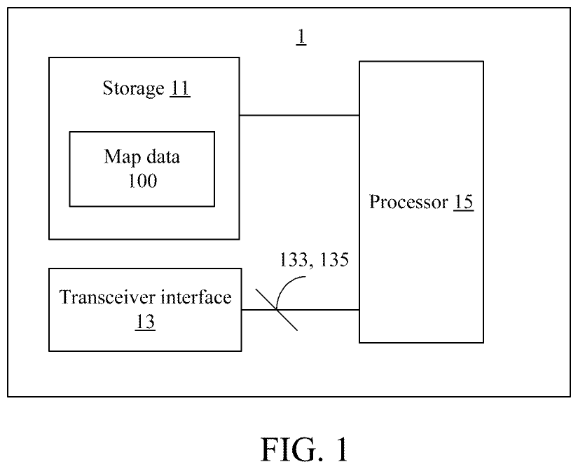

A first embodiment of the present invention is a navigation apparatus 1 and a schematic view of which is depicted in FIG. 1. The navigation apparatus 1 comprises a storage 11, a transceiver interface 13 and a processor 15, wherein the processor 15 is electrically connected to the storage 11 and the transceiver interface 13. The storage 11 may be a memory, a Universal Serial Bus (USB) disk, a hard disk, a Compact Disk (CD), a mobile disk, or any other storage medium or circuit known to those of ordinary skill in the art and having the same functionality. The transceiver interface 13 is an interface capable of receiving and transmitting data or other interfaces capable of receiving and transmitting data and known to those of ordinary skill in the art. The processor 15 may be any of various processors, Central Processing Units (CPUs), microprocessors, digital signal processors or other computing apparatuses known to those of ordinary skill in the art.

In some embodiments, the navigation apparatus 1 can be, but not limited to, a wearable apparatus, a mobile electronic apparatus, or an electronic apparatus installed on a vehicle, or the like. For example, the navigation apparatus 1 can be applied to an indoor space, so as to conduct navigation of the indoor space through the navigation apparatus 1.

In the first embodiment of the present invention, the processor 15 receives input data from the user and at least a piece of positioning information (i.e., includes one or more). Then, the processor 15 performs a semantic analysis on the input data to generate a plurality of pieces of semantic information. Next, the processor 15 selects at least one of the semantic information as a filtering condition, and the processor 15 compares the filtering condition with the semantic tags in the map data to determine whether the semantic tags have at least one first semantic tag that meets the filtering condition (i.e., includes one or more). Finally, the processor 15 generates a comparison result when the processor 15 determines that the semantic tag have the at least one first semantic tag, and the processor 15 generates a navigation route according to the comparison result and the at least a piece of positioning information. The following paragraphs will describe the implementation details related to the present invention in detail, please refer to FIG. 1.

In the present embodiment, the storage 11 stores the map data 100. The map data 100 includes a plurality of objects and a plurality of semantic tags corresponding to each of the objects, each of the semantic tags is used to describe each corresponding object. For example, the map data 100 can be a High-Definition Map (HD Map), each object in the map and the semantic tags corresponding to each object are recorded in the High-Definition Map (e.g., the semantic map in the high-definition map), each semantic tag contains relevant information corresponding to each object. It shall be appreciated that the map data 100 may include various objects and semantic tags. Taking the object as a restaurant as an example, each semantic tag may include the information of the restaurant such as an address, road name, surrounding landmarks, surrounding stores, ratings, menus, recommended dishes, etc., the present invention does not limit the content contained in the semantic tags.

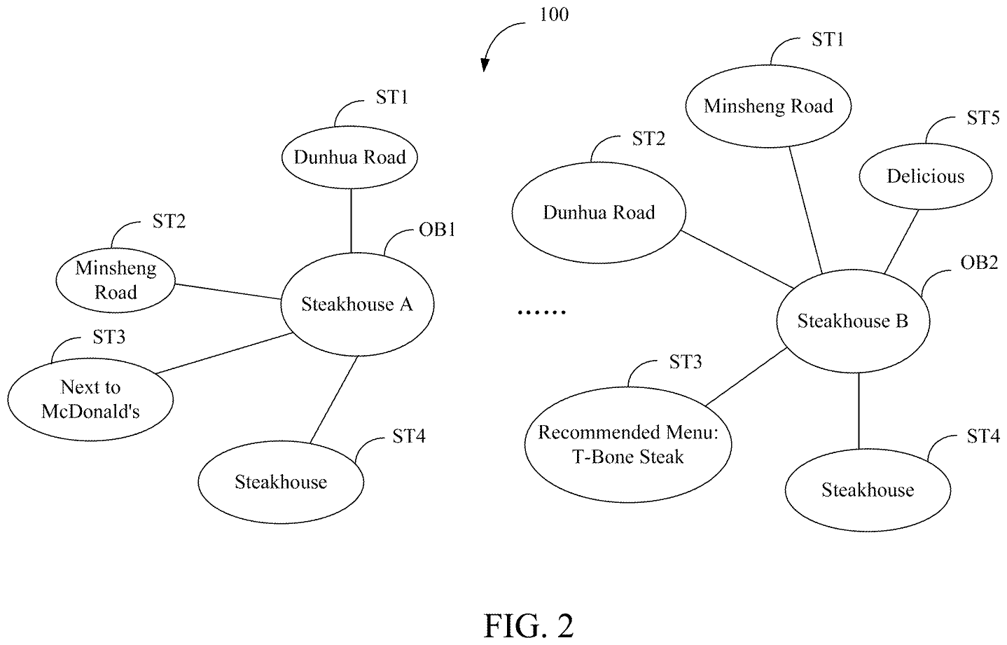

For ease of understanding, FIG. 2 illustrates a schematic view in which the map data 100 includes a plurality of objects and semantic tags. In FIG. 2, the object OB1 “Steakhouse A” and the object OB2 “Steakhouse B” are shown. The object OB1 “Steakhouse A” has the semantic tag ST1 “Dunhua Road”, the semantic tag ST2 “Minsheng Road”, the semantic tag ST3 “Next to McDonald's” and the semantic tag ST4 “Steakhouse”. The object OB2 “Steakhouse B” has the semantic tag ST1 “Minsheng Road”, the semantic tag ST2 “Dunhua Road”, the semantic tag ST3 “Recommended Menu: T-Bone Steak”, the semantic tag ST4 “Steakhouse” and the semantic tag ST5 “Delicious”. It shall be appreciated that FIG. 2 is only for the purpose of illustrating an example of the map data rather than for limiting the scope of the present invention. In the actual operation, the objects and the semantic tags in the map data 100 may contain other necessary content, and may be stored in different forms. Therefore, any method related to objects and objects with information content belongs to the scope of the present invention.

In the present embodiment, the navigation apparatus 1 first receives the input data 133 and at least a piece of positioning information 135 (hereinafter referred to as the positioning information 135). For example, the user can express relevant information about the destination to go to through voice or text. The input data 133 can be voice input received by a microphone or text input generated by a device such as a panel. It shall be appreciated that, in some embodiments, the positioning information 135 may include at least one of the coordinate positions of the navigation apparatus 1, 3D point cloud information around the navigation apparatus 1, the front image of the navigation apparatus 1, the side image of the navigation apparatus 1 and the rear image of the navigation apparatus 1 or a combination thereof.

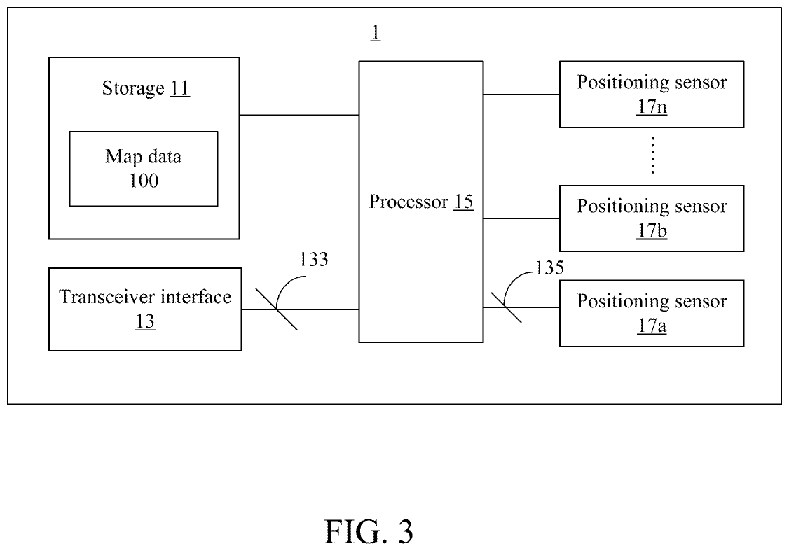

In some embodiments, the navigation apparatus 1 further includes at least one positioning sensor (i.e., includes one or more). As shown in FIG. 3, the navigation apparatus 1 further includes positioning sensors 17a, 17b, . . . , 17n, the positioning sensors 17a, 17b, . . . , 17n are electrically connected to the processor 15, and the positioning sensors 17a, 17b, . . . , 17n are used for generating the positioning information 135 about the navigation apparatus 1. It shall be appreciated that the positioning sensors 17a, 17b, . . . , 17n can be at least one or a combination of positioning sensors such as global positioning systems, cameras, and optical radars, etc. The positioning sensors 17a, 17b, . . . , 17n are used for generating, for example, the coordinate positions of the navigation apparatus 1, 3D point cloud information around the navigation apparatus 1, the front image of the navigation apparatus 1, the side image of the navigation apparatus 1, and the rear image of the navigation apparatus 1. For example, when the navigation apparatus 1 is applied to a self-driving car, the navigation apparatus 1 can receive information such as images or 3D point cloud through cameras, radars, optical radars and other devices equipped on the self-driving car to assist the navigation apparatus 1 for the subsequent analysis and determination.

In the present embodiment, in order to accurately analyze the semantic meaning of the input data 133, the processor 15 performs semantic analysis on the input data 133 to generate a plurality of pieces of semantic information. Subsequently, the processor 15 selects at least one of the semantic information as a filtering condition. Specifically, the processor 15 can perform semantic analysis on the input data 133 through operations such as automatic speech recognition (ASR), computer speech recognition (CSR), speech to text recognition (Speech To Text; STT), and synonym analysis, and extract a plurality of semantic information related to the purpose from the input data 133. It shall be appreciated that which semantic analysis method is used is not the focus of the present invention, which shall be appreciated by those of ordinary skill in the art and thus will not be further described herein.

In some embodiments, the processor 15 further generates a spatial filtering condition based on the positioning information 135, and updates the filtering condition based on the spatial filtering condition. For example, the processor 15 may locate the current position of the navigation apparatus 1 based on the positioning information 135, and set the spatial filtering condition to be within 5 kilometers to narrow the search range of the map data. Therefore, when the processor 15 performs subsequent comparisons, it only searches for objects in the map data within a distance of 5 kilometers from the location of the navigation apparatus 1. In some embodiments, the processor 15 may also directly specify a specific city area (e.g., Zhongshan District, Taipei City) to be compared in the map data. It shall be appreciated that the present invention does not limit the use of any conventional spatial positioning technology. For example, the present invention may use traditional GPS positioning, fusion of sensing information for positioning (e.g., Combination of GPS and surrounding images and/or point cloud image information of the device), and trajectory positioning of historical paths.

In the present embodiment, the processor 15 then compares the filtering condition with the semantic tags in the map data 100 to determine whether the semantic tags have a first semantic tag that meets the filtering condition. It shall be appreciated that the method used by the processor 15 to compare whether keywords appear in semantic tags is not limited in the present invention, and any method that can be used to compare keywords should fall within the scope of the present invention.

In the present embodiment, the processor 15 generates a comparison result when the processor 15 determines that the semantic tags have the first semantic tag, wherein the comparison result is related to the object corresponding to the first semantic tag. Finally, the processor 15 generates a navigation route according to the comparison result and the positioning information.

For ease of understanding, a complete example is taken as an example, but it is not intended to limit the present invention. In the example, the input data 133 received by the navigation apparatus 1 is “Navigate to the steakhouse next to McDonald's at the intersection of Dunhua Road and Minsheng Road”. First, the processor 15 performs semantic analysis on the input data 133 to generate semantic information such as “Dunhua Road”, “Minsheng Road”, “McDonald's” and “Steakhouse”. Subsequently, the processor 15 selects “Dunhua Road”, “Minsheng Road”, “McDonald's” and “Steakhouse” as the filtering condition.

Next, the processor 15 compares the “Dunhua Road”, “Minsheng Road”, “McDonald's” and “Steakhouse” in the filtering condition with the semantic tags in the map data 100, and determines whether there are any semantic tags corresponding to an object in the map data 100 with keywords of “Dunhua Road”, “Minsheng Road”, “McDonald's” and “Steakhouse”. Take the map data 100 in FIG. 2 as an example. The object OB1 “Steakhouse A” in the map data 100 includes the semantic tags ST1, ST2, ST3, and ST4 containing the keywords “Dunhua Road”, “Minsheng Road”, “McDonald's”, and “Steakhouse”, respectively. The object OB2 “Steakhouse B” in the map data 100 includes the semantic tags ST2, ST1, and ST4 containing the keywords “Dunhua Road”, “Minsheng Road”, and “Steakhouse”, respectively. Therefore, when the processor 15 compares the filtering condition with the semantic tags in the map data 100, the processor 15 determines that the filtering condition is completely consistent with the semantic tags of “Steakhouse A”, and therefore generates “Steakhouse A” as the comparison result. Finally, the processor 15 generates a navigation route to “Steakhouse A” according to the positioning location of the navigation apparatus 1.

It shall be appreciated that, in some embodiments, the processor 15 may also generate the comparison result based on the number of semantic tags that meet the filtering condition and a threshold value. For example, when the semantic tags of the object OB3 have more than “n” items that meet the filtering condition (wherein n is a positive integer), the processor 15 may add the object OB3 to the comparison result.

For another example, when the input data 133 is “Is the steakhouse at the intersection of Dunhua Road and Minsheng Road delicious?”, the processor 15 also performs the above operations. First, the processor 15 performs semantic analysis on the input data 133 to generate semantic information such as “Dunhua Road”, “Minsheng Road”, “Steakhouse”, and “Delicious”. Subsequently, the processor 15 selects “Dunhua Road”, “Minsheng Road”, “Steakhouse” and “Delicious” as filtering condition. When the processor 15 compares the filtering condition with the semantic tags in the map data 100, the processor 15 determines that the filtering condition is completely consistent with the semantic tags of “Steakhouse B”, and therefore generates “Steakhouse B” as the comparison result. Finally, the processor 15 generates a navigation route to “Steakhouse B” according to the positioning location of the navigation apparatus 1.

In some embodiments, after the processor 15 generates the comparison result, the display device (not shown) can be used to provide the user for confirmation, and then the navigation to the target can be performed after the user confirms the navigation destination. For example, when the comparison result shows more than two stores, the display device displays multiple comparison results, and the user confirms which store is the navigation target of interest.

In some embodiments, the complete map data 100 may include the huge amount of data, the storage 11 of the navigation apparatus 1 may not be enough to store the complete map data 100 (e.g., the navigation apparatus 1 installed on a vehicle). In some embodiments, the processor 15 may receive an area map data from an external map data server (e.g., a cloud server) according to the comparison result, and the processor 15 generates navigation routes according to the area map data, the comparison result, and the positioning information.

In some embodiments, when the processor 15 is unable to find the semantic tags that meet the filtering condition from the map data 100, it means that the map data 100 may not have this data because the store information has not been updated (e.g., the original address has been changed to another store). In this situation, the storage 11 of the navigation apparatus 1 can pre-store the object features corresponding to each object, for example, image data or three-dimensional patterns of McDonald's, logos of steakhouse, text symbols of various stores, trademark shapes of various stores, the shape of the signboard of various stores, or any feature that can be used to identify the store. Therefore, the navigation apparatus 1 can use the positioning information 135 generated by positioning sensors such as global positioning systems, cameras, and optical radars to perform real-time object feature comparisons with the positioning information 135. The navigation apparatus 1 determines whether there are any objects shows in the surrounding of the current navigation apparatus 1 that meet the filtering condition, and thus further reminds the user to pay attention or to navigate to the target. Specifically, when it is determined that the semantic tags do not have the first semantic tag, the processor 15 is further configured to identify a real-time object feature according to the positioning information 135 to generate an object feature recognition result. Then, the processor 15 compares the filtering condition with the object feature recognition result to determine whether the object feature recognition result meets the filtering condition. Finally, when the processor 15 determines that the object feature recognition result meets the filtering condition, the processor 15 generates the navigation route according to the object feature recognition result and the positioning information.

In some embodiments, when the processor 15 determines that the object feature recognition result meets the filtering condition, the processor 15 generates a new object and a new semantic tag corresponding to the new object according to the at least a piece of positioning information and the filtering condition to update the map data 100.

It shall be appreciated that the navigation apparatus 1 can identify the features of objects in the image/point cloud in real time by analyzing images (e.g., images, 3D point cloud images), perform analysis/classification through various existing analysis methods (e.g., Convolutional Neural Network (CNN), 3D Convolutional Neural Network (3D CNN)) and identify object features to determine whether the target object appears (e.g., trademark image of McDonald's, logo of steakhouse, text of various stores).

In some embodiments, the navigation apparatus 1 can continuously update the map data 100, and does not need to wait for the processor 15 to find that the semantic tags in the map data 100 fail to match the filtering condition. Specifically, the processor 15 generates a new object and a new semantic tag corresponding to the new object based on the positioning information and the filtering condition to update the map data 100.

In some embodiments, the processor 15 may obtain the relevant data of the object through an external database such as a Point Of Interest (POI) database, a search engine, etc., and further confirm whether the result of the feature recognition of the object and the relevant data of the object are matched (e.g., check whether the coordinates of the navigation apparatus 1 and the store's coordinates are the same), and update the object and semantic tags of the map data 100. Specifically, the processor 15 inputs the semantic information into the first external database, and searches for at least one search data related to the semantic information from the first external database. Next, the processor 15 compares at least one search data with the object feature recognition result to determine whether the object feature recognition result matches the search data. Finally, when the object feature recognition result matches the search data, the processor 15 generates the navigation route based on the search data and positioning information, and updates the map data 100 based on the search data.

In some embodiments, the processor 15 may obtain relevant data (e.g., social media information, ratings, menus, prices, recommended dishes) of the object through an external database such as a search engine, and update the relevant data of the object to the map data 100. Specifically, the processor 15 inputs the semantic information into a second external database, and searches for at least one external data related to the semantic information from the second external database. Next, the processor 15 updates the new semantic tag corresponding to the new object in the map data 100 based on the at least one external data.

According to the above descriptions, the navigation apparatus 1 provided by the present invention generates a plurality of pieces of semantic information by performing semantic analysis on input data, selects at least one of the semantic information as a filtering condition, and compares the filtering condition with the semantic tags in the map data to determine whether the semantic tags have at least one first semantic tag that meets the filtering condition. Next, the navigation apparatus 1 generates a comparison result when determining that the semantic tags have the at least one first semantic tag, and generates a navigation route according to the comparison result and the at least a piece of positioning information. The navigation apparatus 1 provided by the present invention generates a navigation route by analyzing the semantic information and comparing the semantic tags of objects in the map data, and solves the problems in the prior art that the conventional technology cannot intelligently assist the user in finding the target for navigation. In addition, the present invention also provides a technology for updating the map data in real-time, thereby overcoming the problem that the conventional technology cannot update the map data in real-time.

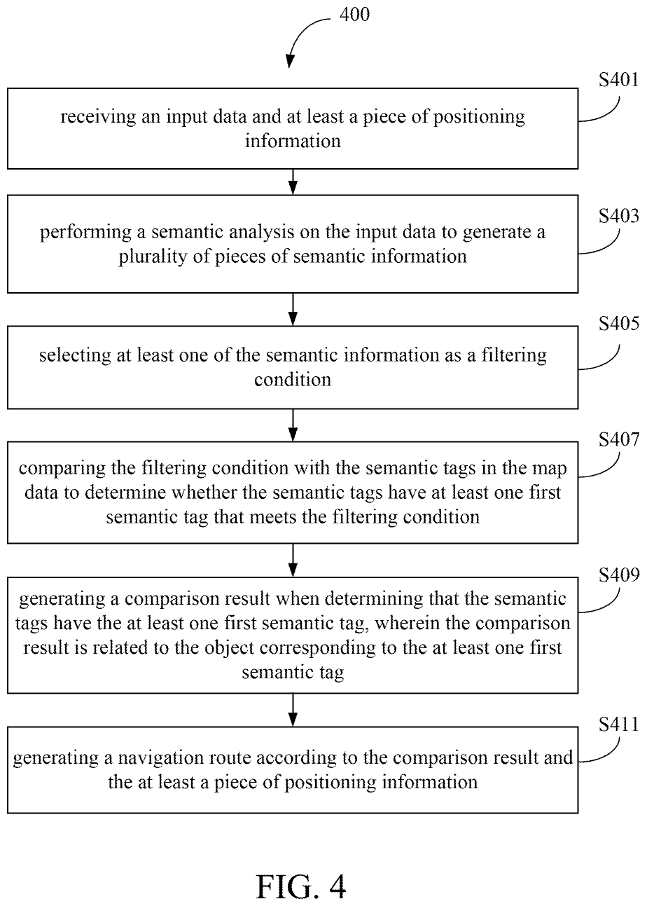

A second embodiment of the present invention is a navigation method and a flowchart thereof is depicted in FIG. 4. The navigation method 400 is adapted for an electronic apparatus (e.g., the navigation apparatus 1 of the first embodiment). The electronic apparatus stores a map data, such as the map data 100 in the first embodiment. The navigation method generates a navigation route through the steps S401 to S411.

In some embodiments, the navigation method 400 further comprises the following steps: receiving an area map data according to the comparison result from an external map data server, generating the navigation route according to the area map data, the comparison result, and the at least a piece of positioning information.

In some embodiments, the electronic apparatus further comprises at least one positioning sensor, such as the positioning sensor 17a, 17b, . . . , 17n in the first embodiment. The at least one positioning sensor is electrically connected to the processor, and is configured to generate the at least a piece of positioning information.

In the step S401, the electronic apparatus receives an input data and at least a piece of positioning information. In the step S403, the electronic apparatus performs a semantic analysis on the input data to generate a plurality of pieces of semantic information.

In the step S405, the electronic apparatus selects at least one of the semantic information as a filtering condition. In some embodiments, the navigation method 400 further comprises the following steps: generating a spatial filtering condition based on the at least a piece of positioning information; and updating the filtering condition based on the spatial filtering condition.

In the step S407, the electronic apparatus compares the filtering condition with the semantic tags in the map data to determine whether the semantic tags have at least one first semantic tag that meets the filtering condition. Next, in step S409, the electronic apparatus generates a comparison result when determining that the semantic tags have the at least one first semantic tag, wherein the comparison result is related to the object corresponding to the at least one first semantic tag. Thereafter, in step S411, the electronic apparatus generates a navigation route according to the comparison result and the at least a piece of positioning information.

In some embodiments, the navigation method 400 further comprises the following steps: when it is determined that the semantic tags do not have the at least one first semantic tag, identifying a real-time object feature according to the at least a piece of positioning information to generate an object feature recognition result; comparing the filtering condition with the object feature recognition result to determine whether the object feature recognition result meets the filtering condition; and when it is determined that the object feature recognition result meets the filtering condition, generating the navigation route according to the object feature recognition result and the at least a piece of positioning information.

In some embodiments, the navigation method 400 further comprises the following steps: when it is determined that the object feature recognition result meets the filtering condition, generating a new object and a new semantic tag corresponding to the new object according to the at least a piece of positioning information and the filtering condition to update the map data.

In some embodiments, the navigation method 400 further comprises the following steps: generating a new object and a new semantic tag corresponding to the new object based on the at least a piece of positioning information and the filtering condition to update the map data.

In some embodiments, the navigation method 400 further comprises the following steps: inputting the semantic information into a first external database, and searching for at least one search data related to the semantic information from the first external database; comparing the at least one search data with the object feature recognition result to determine whether the object feature recognition result matches the search data; and when the object feature recognition result matches the search data, generating the navigation route based on the search data and t the at least a piece of positioning information, and updating the map data based on the search data.

In some embodiments, the navigation method 400 further comprises the following steps: inputting the semantic information into a second external database, and searching for at least one external data related to the semantic information from the second external database; and updating the new semantic tag corresponding to the new object in the map data based on the at least one external data.

In addition to the aforesaid steps, the second embodiment can also execute all the operations and steps of the navigation apparatus 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

It shall be appreciated that in the specification and the claims of the present invention, some words (e.g., semantic tag and external database) are preceded by terms such as “first” or “second,” and these terms of “first” and “second” are only used to distinguish these different words. For example, the “first” and “second” in the first external database and the second external database are only used to indicate the external database used in different embodiments.

According to the above descriptions, the navigation technology (including the apparatus and the method) provided by the present invention generates a plurality of pieces of semantic information by performing semantic analysis on input data, selects at least one of the semantic information as a filtering condition, and compares the filtering condition with the semantic tags in the map data to determine whether the semantic tags have at least one first semantic tag that meets the filtering condition. Next, the navigation technology generates a comparison result when determining that the semantic tags have the at least one first semantic tag, and generates a navigation route according to the comparison result and the at least a piece of positioning information. The navigation technology provided by the present invention generates a navigation route by analyzing the semantic information and comparing the semantic tags of objects in the map data, and solves the problems in the prior art that the conventional technology cannot intelligently assist the user in finding the target for navigation. In addition, the present invention also provides a technology for updating the map data in real-time, thereby overcoming the problem that the conventional technology cannot update the map data in real-time.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A navigation apparatus, comprising:
a storage, configured to store a map data, wherein the map data includes a plurality of objects and a plurality of semantic tags corresponding to each of the objects, each of the semantic tags is used to describe each corresponding object;
a transceiver interface; and
a processor, electrically connected to the storage and the transceiver interface, and configured to perform following operations:
receiving an input data and at least a piece of positioning information;
performing a semantic analysis on the input data to generate a plurality of pieces of semantic information;
selecting at least one of the semantic information as a filtering condition;
comparing the filtering condition with the semantic tags in the map data to determine whether the semantic tags have at least one first semantic tag that meets the filtering condition;
generating a comparison result when determining that the semantic tags have the at least one first semantic tag, wherein the comparison result is related to the object corresponding to the at least one first semantic tag; and
generating a navigation route according to the comparison result and the at least a piece of positioning information.

2. The navigation apparatus of claim 1, wherein the processor further performs following operations:
receiving an area map data according to the comparison result from an external map data server, generating the navigation route according to the area map data, the comparison result, and the at least a piece of positioning information.

3. The navigation apparatus of claim 1, wherein the navigation apparatus further comprises:
at least one positioning sensor, electrically connected to the processor, and configured to generate the at least a piece of positioning information.

4. The navigation apparatus of claim 1, wherein the processor further performs following operations:
generating a spatial filtering condition based on the at least a piece of positioning information; and
updating the filtering condition based on the spatial filtering condition.

5. The navigation apparatus of claim 1, wherein the processor further performs following operations:
when it is determined that the semantic tags do not have the at least one first semantic tag, identifying a real-time object feature according to the at least a piece of positioning information to generate an object feature recognition result;
comparing the filtering condition with the object feature recognition result to determine whether the object feature recognition result meets the filtering condition; and
when it is determined that the object feature recognition result meets the filtering condition, generating the navigation route according to the object feature recognition result and the at least a piece of positioning information.

6. The navigation apparatus of claim 5, wherein the processor further performs following operations:
when it is determined that the object feature recognition result meets the filtering condition, generating a new object and a new semantic tag corresponding to the new object according to the at least a piece of positioning information and the filtering condition to update the map data.

7. The navigation apparatus of claim 1, wherein the processor further performs following operations:
generating a new object and a new semantic tag corresponding to the new object based on the at least a piece of positioning information and the filtering condition to update the map data.

8. The navigation apparatus of claim 5, wherein the processor further performs following operations:
inputting the semantic information into a first external database, and searching for at least one search data related to the semantic information from the first external database;
comparing the at least one search data with the object feature recognition result to determine whether the object feature recognition result matches the search data; and
when the object feature recognition result matches the search data, generating the navigation route based on the search data and the at least a piece of positioning information, and updating the map data based on the search data.

9. The navigation apparatus of claim 6, wherein the processor further performs following operations:
inputting the semantic information into a second external database, and searching for at least one external data related to the semantic information from the second external database; and
updating the new semantic tag corresponding to the new object in the map data based on the at least one external data.

10. A navigation method, adapted for use in an electronic apparatus, the electronic apparatus comprised a storage, a transceiver interface and a processor, the storage storing a map data, wherein the map data includes a plurality of objects and a plurality of semantic tags corresponding to each of the objects, each of the semantic tags is used to describe each corresponding object, and the navigation method is executed by the processor and comprises the following steps:
receiving an input data and at least a piece of positioning information;
performing a semantic analysis on the input data to generate a plurality of pieces of semantic information;
selecting at least one of the semantic information as a filtering condition;
comparing the filtering condition with the semantic tags in the map data to determine whether the semantic tags have at least one first semantic tag that meets the filtering condition;
generating a comparison result when determining that the semantic tags have the at least one first semantic tag, wherein the comparison result is related to the object corresponding to the at least one first semantic tag; and
generating a navigation route according to the comparison result and the at least a piece of positioning information.

11. The navigation method of claim 10, further comprising the following steps:
receiving an area map data according to the comparison result from an external map data server, generating the navigation route according to the area map data, the comparison result, and the at least a piece of positioning information.

12. The navigation method of claim 10, wherein the electronic apparatus further comprises:
at least one positioning sensor, electrically connected to the processor, and configured to generate the at least a piece of positioning information.

13. The navigation method of claim 10, further comprising the following steps:
generating a spatial filtering condition based on the at least a piece of positioning information; and
updating the filtering condition based on the spatial filtering condition.

14. The navigation method of claim 10, further comprising the following steps:
when it is determined that the semantic tags do not have the at least one first semantic tag, identifying a real-time object feature according to the at least a piece of positioning information to generate an object feature recognition result;
comparing the filtering condition with the object feature recognition result to determine whether the object feature recognition result meets the filtering condition; and
when it is determined that the object feature recognition result meets the filtering condition, generating the navigation route according to the object feature recognition result and the at least a piece of positioning information.

15. The navigation method of claim 14, further comprising the following steps:
when it is determined that the object feature recognition result meets the filtering condition, generating a new object and a new semantic tag corresponding to the new object according to the at least a piece of positioning information and the filtering condition to update the map data.

16. The navigation method of claim 10, further comprising the following steps:
generating a new object and a new semantic tag corresponding to the new object based on the at least a piece of positioning information and the filtering condition to update the map data.

17. The navigation method of claim 14, further comprising the following steps:
inputting the semantic information into a first external database, and searching for at least one search data related to the semantic information from the first external database;
comparing the at least one search data with the object feature recognition result to determine whether the object feature recognition result matches the search data; and
when the object feature recognition result matches the search data, generating the navigation route based on the search data and the at least a piece of positioning information, and updating the map data based on the search data.

18. The navigation method of claim 15, further comprising the following steps:
inputting the semantic information into a second external database, and searching for at least one external data related to the semantic information from the second external database; and
updating the new semantic tag corresponding to the new object in the map data based on the at least one external data.
